(19) United States
(12) Patent Application Publication
(10) Pub. No.: US 2011/0194430 A1
(43) Pub. Date: Aug. 11, 2011

(54) METHOD AND APPARATUS FOR UNIFIED CHANNEL ESTIMATION FOR WIRELESS COMMUNICATION

(75) Inventors: Taesang Yoo, San Diego, CA (US); Tao Luo, San Diego, CA (US); Yongbin Wei, San Diego, CA (US); Hanfang Pan, San Diego, CA (US); Michael A. Howard, San Diego, CA (US)

(73) Assignee: QUALCOMM INCORPORATED, San Diego, CA (US)

(21) Appl. No.: 12/968,674

(22) Filed: Dec. 15, 2010

Related U.S. Application Data
(60) Provisional application No. 61/288,152, filed on Dec. 18, 2009.

(51) Int. Cl. H04W 24/00

(52) U.S. Cl. 370/252

(57) ABSTRACT

Certain aspects of the disclosure propose a unified channel estimation algorithm that combines two or more channel estimation algorithms in a single piece of hardware or software. The proposed unified channel estimation may dynamically switch, based on one or more metrics, between different modes of operation that utilize different channel estimation algorithms.

### CLAIM OF PRIORITY UNDER 35 U.S.C. §119

This application claims priority to U.S. Provisional Application No. 61/288,152, entitled, “Unified Channel Estimation Architecture for Wireless Communication,” filed Dec. 18, 2009, and assigned to the assignee hereof and hereby expressly incorporated by reference herein.

### BACKGROUND

1. Technical Field

This disclosure generally relates to communication and, more specifically, to providing efficient channel estimation for wireless communication.

2. Background

The third Generation Partnership Project (3GPP) Long Term Evolution (LTE) represents a major advance in cellular technology and is the next step forward in cellular 3G services as a natural evolution of Global System for Mobile Communications (GSM) and Universal Mobile Telecommunications System (UMTS). LTE provides for an uplink speed of up to 50 megabits per second (Mbps) and a downlink speed of up to 100 Mbps and brings many technical benefits to cellular networks. LTE is designed to meet carrier needs for high-speed data and media transport as well as high-capacity voice support. Bandwidth is scalable from 1.25 MHz to 20 MHz. This suits the needs of different network operators that have different bandwidth allocations, and also allows operators to provide different services based on spectrum. LTE is also expected to improve spectral efficiency in 3G networks, allowing carriers to provide more data and voice services over a given bandwidth. LTE encompasses high-speed data, multimedia unicast, and multimedia broadcast services.

Physical layer (PHY) of the LTE standard is a highly efficient means of conveying both data and control information between an enhanced base station (eNodeB) and mobile user equipment (UE). The LTE PHY employs advanced technologies that are new to cellular applications. These include Orthogonal Frequency Division Multiplexing (OFDM) and Multiple Input Multiple Output (MIMO) data transmission. In addition, the LTE PHY uses Orthogonal Frequency Division Multiple Access (OFDMA) on the downlink (DL) and Single Carrier-Frequency Division Multiple Access (SC-FDMA) on the uplink (UL). OFDMA allows data to be directed to or from multiple users on a subcarrier-by-subcarrier basis for a specified number of symbol periods.

LTE-Advanced is an evolving mobile communication standard for providing 4G services. Among other things, LTE-Advanced, also called International Mobile Telecommunications-Advanced (IMT-Advanced), meet the requirements for 4G as defined by the International Telecommunication Union including peak data rates up to 1 Gbit/s. Besides the peak data rate, LTE-Advanced also targets faster switching between power states and improved performance at the cell edge.

### SUMMARY

Certain aspects of the disclosure provide a method for wireless communications. The method generally includes calculating at least one metric utilizing reference signals received from a plurality of apparatuses, and dynamically switching among a plurality of channel estimation modes based on the at least one metric.

Certain aspects of the disclosure provide an apparatus for wireless communications. The apparatus generally includes logic for calculating at least one metric utilizing reference signals received from a plurality of apparatuses, and logic for dynamically switching among a plurality of channel estimation modes based on the at least one metric.

Certain aspects of the disclosure provide an apparatus for wireless communications. The apparatus generally includes means for calculating at least one metric utilizing reference signals received from a plurality of apparatuses, and means for dynamically switching among a plurality of channel estimation modes based on the at least one metric.

Certain aspects provide a computer-program product comprising a non-transitory computer-readable medium including code for causing at least one processor to calculate at least one metric utilizing reference signals received from a plurality of apparatuses, and code for causing at least one processor to dynamically switch among a plurality of channel estimation modes based on the at least one metric.

Certain aspects of the disclosure provide an apparatus for wireless communications. The apparatus generally includes at least one processor configured to calculate at least one metric utilizing reference signals received from a plurality of apparatuses, and dynamically switch among a plurality of channel estimation modes based on the at least one metric, and a memory coupled to the at least one processor.

### BRIEF DESCRIPTION OF THE DRAWINGS

FIG. 1 illustrates a multiple access wireless communication system, in accordance with certain aspects of the disclosure.

FIG. 2 illustrates a block diagram of multiple input multiple output (MIMO) communication system, in accordance with certain aspects of the disclosure.

FIG. 3 illustrates an example wireless communication system, in accordance with certain aspects of the disclosure.

FIG. 4 illustrates an example block diagram of a wireless communication system, in accordance with certain aspects of the disclosure.

FIG. 5 illustrates an example block diagram of unified channel estimation architecture, in accordance with certain aspects of the disclosure.

FIG. 6 illustrates example operations for efficient channel estimation, in accordance with certain aspects of the disclosure.

FIG. 6A illustrates example components capable of performing the operations illustrated in FIG. 6.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE)802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency.

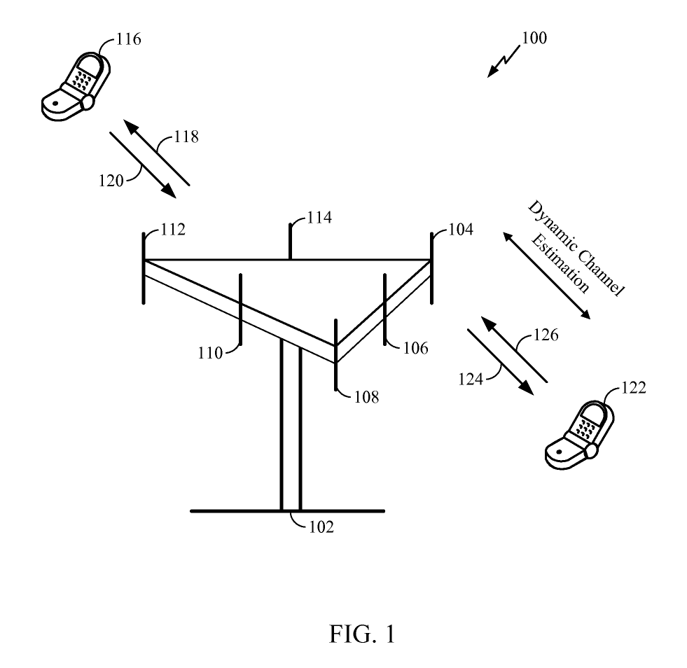

Referring to FIG. 1, a multiple access wireless communication system 100 according to one aspect is illustrated. An access point 102 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 104 and 106, where antennas 104 and 106 transmit information to access terminal 122 over downlink or forward link 124 and receive information from access terminal 122 over uplink or reverse link 126. In a Frequency Division Duplex (FDD) system, communication links 118, 120, 124 and 126 may use a different frequency for communication. For example, downlink or forward link 118 may use a different frequency than that used by uplink or reverse link 120.

For certain aspects, the AP 102 or the access terminals 116, 122 may utilize a unified channel estimation algorithm and dynamically switch among different channel estimation modes.

Each group of antennas and/or the area in which they are designed to communicate is often referred to as a sector of the access point. In an aspect, antenna groups each are designed to communicate to access terminals in a sector of the areas covered by access point 102.

In communication over downlinks or forward links 118 and 124, the transmitting antennas of access point 102 utilize beamforming in order to improve the signal-to-noise ratio (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology.

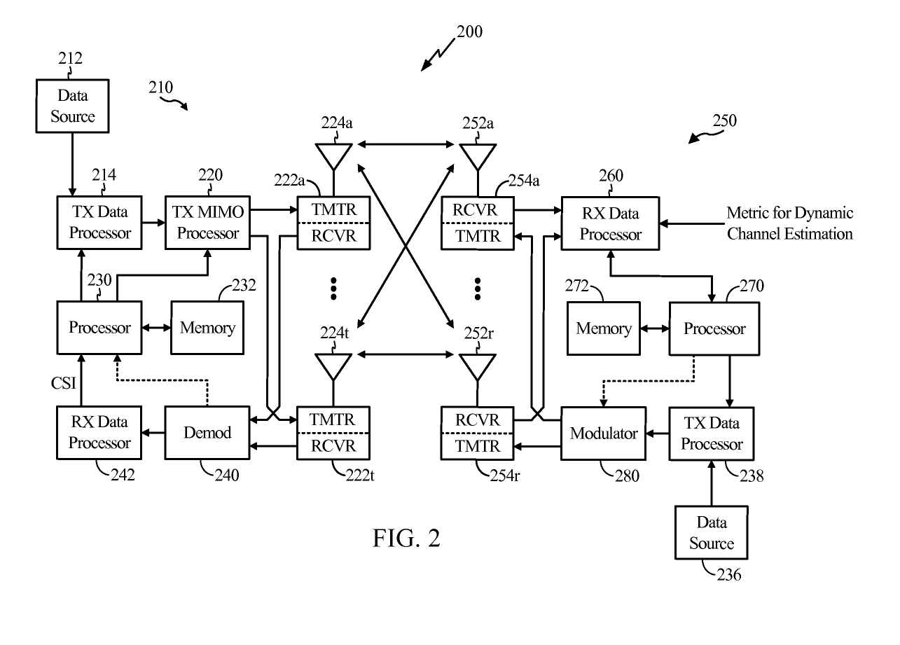

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation) selected for that data stream to provide modulation symbols. The data rate, coding and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210. As described in further detail below, the RX data processor 260 may calculate a metric and dynamically select a channel estimation mode based on the metric.

Processor 270, coupled to a memory 272, formulates a reverse or uplink message. The reverse link message may comprise various types of information regarding the communication link and/or the received data stream. The reverse or uplink message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve or uplink message transmitted by the receiver system 250.

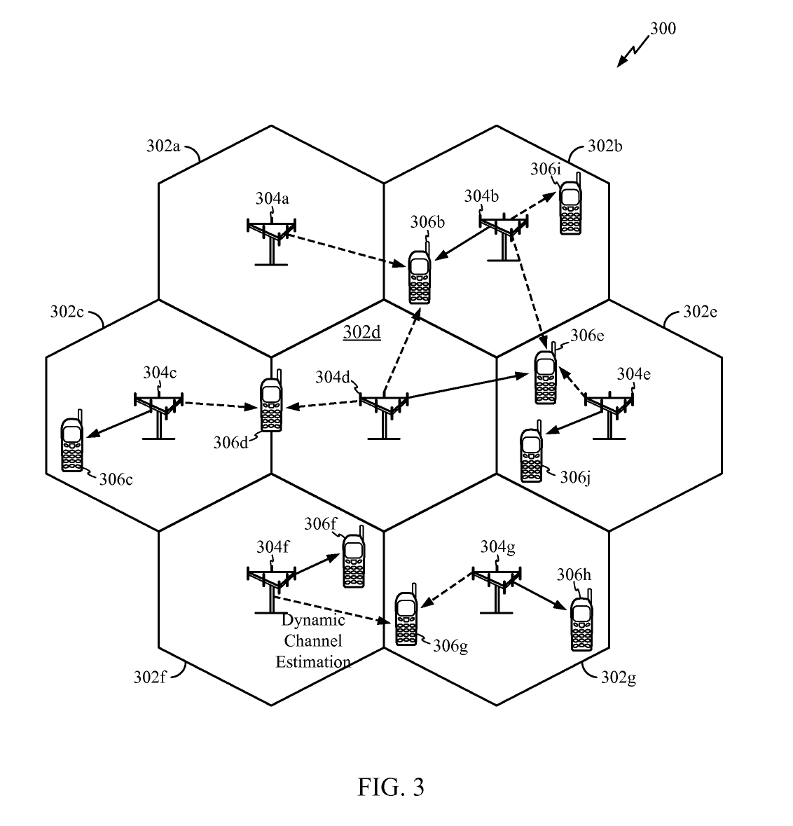

FIG. 3 illustrates an example wireless communication system 300 configured to support a number of users, in which various disclosed aspects may be implemented. As shown in FIG. 3, by way of example, system 300 provides communication for multiple cells 302, such as, for example, macro cells 302a-302g, with each cell being serviced by a corresponding access point AP 304 (such as APs 304a-304g). Each cell may be further divided into one or more sectors (e.g., to serve one or more frequencies). Various access terminals ATs 306, including ATs 306b-306j, also known interchangeably as user equipment (UE) or mobile stations, are dispersed throughout the system.

Each UE 306 may communicate with one or more APs 304 on an uplink or reverse link and/or a downlink or forward link at a given moment, depending upon whether the UE is active and whether it is in soft handoff, for example. The wireless communication system 300 may provide service over a large geographic region, and macro cells 302a-302g may cover a small geographic area.

Certain aspects of the present disclosure propose a unified channel estimation architecture that combines two or more channel estimation algorithms in a single hardware and/or software implementation. The proposed architecture may dynamically switch between different modes of operation that utilize different channel estimation algorithms.

In a heterogeneous network, a UE may improve its performance by utilizing Interference Cancellation (IC) to eliminate interference caused by transmissions from other UEs and/or access points. Cancelling the interference in broadcast signals such as primary synchronization signal (PSS), secondary synchronization signal (SSS), physical broadcast channel (PBCH), and common reference signals (CRS) may enable deep penetration of those signals. Interference cancellation may enhance UE experience by eliminating coverage holes created by strong interferers. Since reference signals may be present over the entire system bandwidth and on every subframe, an interference cancellation (IC) technique that utilizes reference signals (RSs) may enhance decoding and measurement performance of a UE.

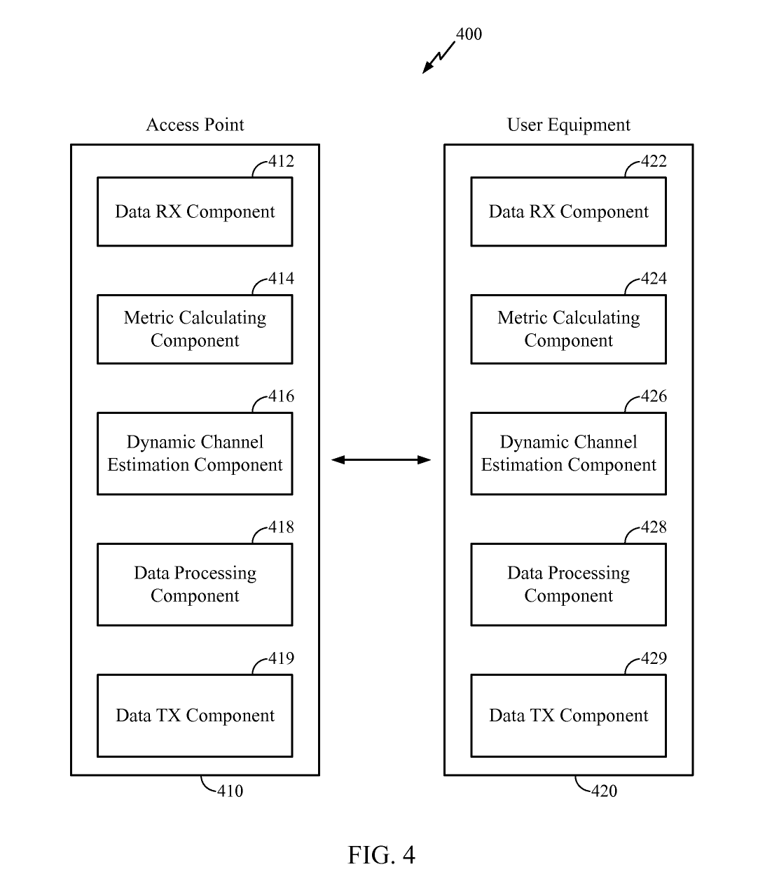

FIG. 4 illustrates an example block diagram of a wireless communication system comprising an access point and a user equipment, in accordance with certain aspects of the disclosure. The access point 410 may transmit downlink signals, including reference signals, to the UE 420 and receive uplink signals from the UE. Using the received reference signals, the UE may estimate channel characteristics of the communication link. Based on the amount of interference on the received signal, the UE may select a suitable (e.g., preferred) channel estimation algorithm. According to certain aspects, a UE may dynamically select its preferred channel estimation algorithm. Similarly, an access point may dynamically select its preferred channel estimation algorithm based on the characteristics of the received signal.

As illustrated in FIG. 4, the UE may comprise a data receiving component 422 that receives signals from the AP. The UE 420 may calculate one or more metrics based on the characteristics of the received signals by utilizing a metric calculating component 424. The UE may also have a dynamic channel estimation component 426 that dynamically selects a channel estimation algorithm among two or more channel estimation algorithms based on the metrics. As an example, the UE may select a channel estimation algorithm that utilizes interference cancellation if the received signal is distorted with the signals from interferers.

The UE may process the received signal based on the estimated channel using a data processing component 428. The UE may transmit data to the access point utilizing data transmitting component 429.

Similarly, the AP 410 may receive the signal using a data receiving component 412, calculate one or more metrics using a metric calculating component 414, select a preferred channel estimation algorithm using a dynamic channel estimation component 416, process the received data using the data processing component 418, and transmit data to the UE using data transmitting component 419.

Certain aspects of the disclosure present a method for coexistence of a plurality of channel estimation algorithms in a hardware architecture, a digital signal processor (DSP) or a piece of software code. One or more of the plurality of channel estimation algorithms may utilize interference cancellation. Interference cancellation may only be necessary when a UE receives strong interference from a node. It should be noted that it may be possible to design a single channel estimation algorithm that operates both with and without common reference signal interference cancellation (CRS IC). However, the algorithm may not perform as well as other algorithms that are optimized for different scenarios.

For certain aspects of the disclosure, two or more channel estimation algorithms may be used in a device. Each of the channel estimation algorithms may be optimized for a certain scenario. For example, a first channel estimation algorithm (CE1) may be used for scenarios without a strong interferer when CRS IC is not necessary. Therefore, the CE1 may be optimized for best performance. Another channel estimation algorithm (CE2) may be used when CRS IC is preferred, for example, when one or more strong interferers are present. The device may dynamically switch among different channel estimation algorithms depending on the characteristics of the system.

Channel estimation algorithms that utilize interference cancellation may perform more computations than the channel estimation algorithms that do not perform IC. The computations may be performed either in hardware or in a DSP. Computational complexity of a channel estimator algorithm may be proportional to the number of interferers that needs to be canceled out. Therefore, there may be a trade-off between performance and hardware or software complexity (e.g., in terms of area and speed) in design of an architecture or a piece of code for a channel estimation algorithm that cancels effects of one or more interferers (e.g., CE2).

At any given time, either CE1 or CE2 may be used. Therefore, for certain aspects, a single hardware or a single piece of software may be designed to function as either CE1 or CE2. This may result in reduced design work and savings in terms of hardware area and power consumption.

Certain aspects of the disclosure present a unified channel estimation algorithm that combines two or more channel estimation algorithms (e.g., CE1, CE2, etc.) into a single hardware or software code implementation. The proposed implementation may switch operational mode between different channel estimation algorithms dynamically based on a metric.

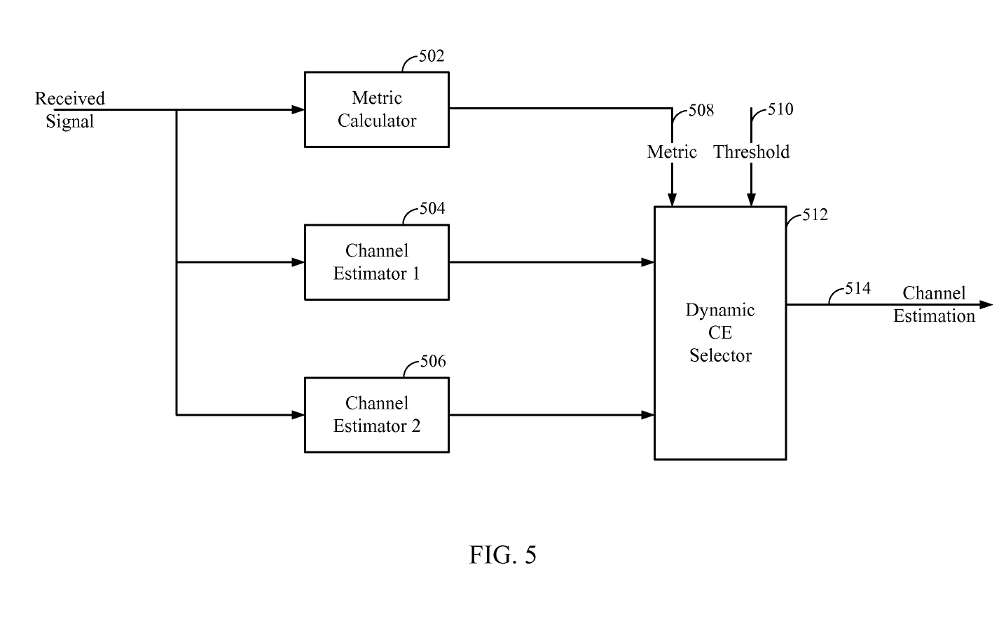

FIG. 5 illustrates an example block diagram of a unified channel estimator, in accordance with certain aspects of the disclosure. The unified channel estimator may include a metric calculating component 424 and dynamic channel estimation component 426 as shown in FIG. 4. The unified channel estimator may input received signal and send it to a metric calculator block 502. The metric calculator block 502 may calculate a metric 508 such as signal-to-noise ratio (SNR), signal to interference plus noise ratio (SINR) or the like to be used in selecting a preferred channel estimation algorithm.

The dynamic channel estimation selector 512 may select a first channel estimator 504 or a second channel estimator 506 by comparing the metric 508 with a threshold 510. For example, the dynamic CE selector block may select CE1 504 if the metric is greater than the threshold and select CE2 506 if the metric is smaller than or equal to the threshold. The dynamic channel estimation component may output a channel estimation value 514 that is calculated using the preferred channel estimation algorithm. It should be noted that although two channel estimator blocks are shown in the figure, the proposed unified channel estimator may include any number of channel estimator blocks, each utilizing different algorithms.

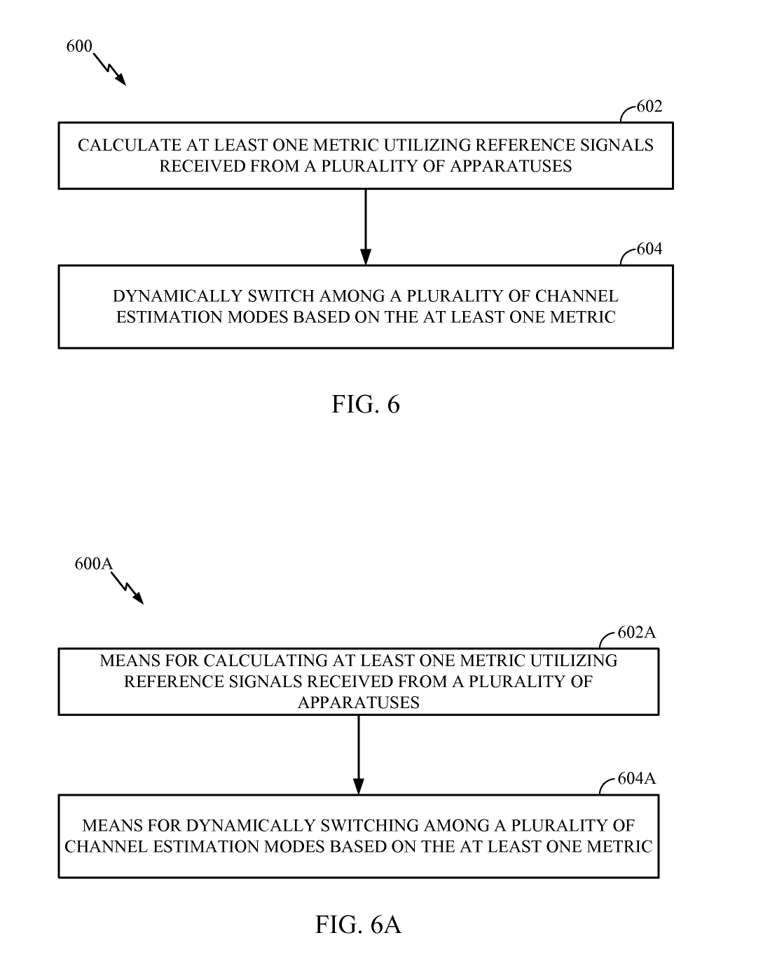

FIG. 6 illustrates example operations for unified channel estimation, in accordance with certain aspects of the disclosure. At 602, a device (e.g., a UE) may calculate at least one metric utilizing reference signals received from a plurality of apparatuses. For example, the metric may be derived based at least on received signal strength and signal-to-noise ratio of the received signals. Also, the plurality of apparatuses may include a serving access point and one or more neighboring APs or other interfering devices. At 604, the device may dynamically switch among a plurality of channel estimation modes based on the metric.

For example, the device may switch between a first channel estimation algorithm and a second channel estimation algorithm based on the metric. The first channel estimation algorithm may be an algorithm optimized for a case when no strong interferer is present. The second channel estimation algorithm may perform CRS IC and may be designed to work well under presence of strong interferers.

For certain aspects, the metric may be calculated based on signal strength or SNR of each node. Or, the UE may estimate the metric based on the received reference signal. The UE may estimate one or more metrics for the signal quality of its serving AP and one or more neighboring APs.

For certain aspects, a channel estimation algorithm with interference cancellation may be selected if there is at least one neighboring AP whose signal strength or SNR is greater than a certain threshold relative to the signal strength or SNR of the serving cell. If there are no interferers, a channel estimation algorithm that does not cancel interference may be selected.

For certain aspects, a flexible decoding timeline that accommodates possibly different amounts of non-causal RS filter lengths may be used in different channel estimation algorithms.

For certain aspects, operational mode of the system may seamlessly switch between different channel estimation algorithms. For example, the proposed system may use a first channel estimation algorithm that does not use CRS IC, and a second channel estimation algorithm that uses CRS IC, and seamlessly switch between the two algorithms based on a metric.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in figures, those operations may have corresponding counterpart means-plus-function components with similar numbering.

For example, operations 600 illustrated in FIG. 6 correspond to means plus function blocks 600A illustrated in FIG. 6A. The means for calculating one or more metrics 602A may comprise any suitable type of calculating component, such as the metric calculating component 424 of the user equipment 420 illustrated in FIG. 4. The means for dynamically switching between two or more channel estimation algorithms 604A may comprise any suitable type of switching component, such as the dynamic channel estimation component 426 of the user equipment 420 illustrated in FIG. 4. These components may be implemented with any suitable components, such as one or more processors, for example, such as the RX data processor 260 and/or processor 270 of the receiver system 250 illustrated in FIG. 2.

The various illustrative logical blocks, modules and circuits described in connection with the disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the disclosure, other and further aspects of the disclosure may be devised without departing from the basic scope thereof, and the scope thereof is determined by the claims that follow.

What is claimed is:

1. A method for wireless communications, comprising:
calculating at least one metric utilizing reference signals received from a plurality of apparatuses; and
dynamically switching among a plurality of channel estimation modes based on the at least one metric.

2. The method of claim 1, wherein the switching further comprises:
switching between a first channel estimation algorithm and a second channel estimation algorithm based on the at least one metric.

3. The method of claim 2, further comprising:
selecting the first channel estimation algorithm if the at least one metric is greater than or equal to a threshold.

4. The method of claim 2, wherein the first channel estimation algorithm is an algorithm optimized for a case when no strong interferer is present.

5. The method of claim 2, wherein the second channel estimation algorithm performs common reference signal interference cancellation (CRS IC) and is designed to work under presence of strong interferers.

6. The method of claim 1, wherein the at least one metric is derived based at least on received signal strength and signal-to-noise ratio of the received reference signals.

7. The method of claim 1, wherein at least one of the plurality of channel estimation modes uses an interference cancellation technique.

8. An apparatus for wireless communications, comprising:
logic for calculating at least one metric utilizing reference signals received from a plurality of apparatuses; and
logic for dynamically switching among a plurality of channel estimation modes based on the at least one metric.

9. The apparatus of claim 8, wherein the logic for switching comprises:
logic for switching between a first channel estimation algorithm and a second channel estimation algorithm based on the at least one metric.

10. The apparatus of claim 9, further comprising:
logic for selecting the first channel estimation algorithm if the at least one metric is greater than or equal to a threshold.

11. The apparatus of claim 9, wherein the first channel estimation algorithm is an algorithm optimized for a case when no strong interferer is present.

12. The apparatus of claim 9, wherein the second channel estimation algorithm performs common reference signal interference cancellation (CRS IC) and is designed to work under presence of strong interferers.

13. The apparatus of claim 8, wherein the at least one metric is derived based at least on received signal strength and signal-to-noise ratio of the received reference signals.

14. The apparatus of claim 8, wherein at least one of the plurality of channel estimation modes uses an interference cancellation technique.

15. An apparatus for wireless communications, comprising:
means for calculating at least one metric utilizing reference signals received from a plurality of apparatuses; and
means for dynamically switching among a plurality of channel estimation modes based on the at least one metric.

16. The apparatus of claim 15, wherein the means for switching comprises:
means for switching between a first channel estimation algorithm and a second channel estimation algorithm based on the at least one metric.

17. The apparatus of claim 16, further comprising:
means for selecting the first channel estimation algorithm if the at least one metric is greater than or equal to a threshold.

18. The apparatus of claim 16, wherein the first channel estimation algorithm is an algorithm optimized for a case when no strong interferer is present.

19. The apparatus of claim 16, wherein the second channel estimation algorithm performs common reference signal interference cancellation (CRS IC) and is designed to work under presence of strong interferers.

20. The apparatus of claim 15, wherein the at least one metric is derived based at least on received signal strength and signal-to-noise ratio of the received reference signals.

21. The apparatus of claim 15, wherein at least one of the plurality of channel estimation modes uses an interference cancellation technique.

22. A computer-program product, comprising:
a computer readable medium comprising:
code for causing at least one processor to calculate at least one metric utilizing reference signals received from a plurality of apparatuses; and
code for causing at least one processor to dynamically switch among a plurality of channel estimation modes based on the at least one metric.

23. An apparatus for wireless communications, comprising at least one processor configured to:
calculate at least one metric utilizing reference signals received from a plurality of apparatuses, and
dynamically switch among a plurality of channel estimation modes based on the at least one metric; and
a memory coupled to the at least one processor.
